(19) United States
(12) Patent Application Publication
(10) Pub. No.: US 2004/0173103 A1
(43) Pub. Date: Sep. 9, 2004

(54) Full-automatic cooking machine

(76) Inventor: James Won, Victorville, CA (US)

Correspondence Address: James Won, 6961 SVL Box, Victorville, CA, 92392, US

(21) Appl. No.: 10/378,131

(22) Filed: Mar. 4, 2003

(51) Int. Cl. A47J 37/10; A23L 1/00

(52) U.S. Cl. 99/326; 99/423

(57) ABSTRACT

A full-automatic cooking machine comprises a raw ingredient storage and supply section, a pre-cooking section, a cooking section, and a electric control cabinet integrated into a box-shaped machine. A programmable controller controls all the action of the machine. The raw ingredient storage and supply section has an alley formed with hundreds of supply drawer. A servo manipulator moves along the alley to collect raw ingredients, then dispenses them into a frying pan in the cooking section. The cooking section has four frying pans mounted on a turntable capable of revolving the four frying pans to four working station: pre-heating station, loading station, stir-frying station, and clean station. They work in a parallel way. A pendent servo robot arm with spatula works on the stir-frying section.

### CROSS-REFERENCE TO RELATED APPLICATION

Not applicable.

### BACKGROUND

1. Field of Invention

This invention relates to a cooking equipment for kitchen automation, specifically to a full-automatic cooking machine controlled with a programmable controller.

2. Description of Prior Art

The preparing of food for meals is a complicated as well as labored job both in family and in restaurant. People spend too much time and energy on meal preparing.

In order to reduce the labor intensity and the waste of time, people have been inventing many machines to help with food preparing, of which the raw ingredient cutting machines have been used widely recent years. These machines can cut raw ingredients (vegetables, meals, etc.) into pieces, slices and shreds easily.

However, cooking is certainly the most arduous procedure of meal preparing, especially for Chinese dishes. In Chinese dishes cooking, too many raw ingredients, seasonings (green onion, ginger, garlic, etc.), condiments (salt, sugar, pepper, etc.) and sauces (soy sauce, vinegar, wine, etc.) have been used, and the procedure and the timing are very complicated.

The first step of cooking is to collect the raw ingredients of the dish ordered. The assistant of the cook has to collect the various ingredients of the dish according to the recipe manually, therefore the quantity of various ingredients can not be the same for the same kind of dish every time, consequently making the taste of the dishes inconsistent.

Picture the cook, standing by the scorching oven with a frying pan in one hand, has to add various ingredients into the pan at the right time according to the recipe while continuously stirring them with a spatula in the other hand, suffering from the high temperature and harmful smoke.

Although some machines have been used to reduce the suffering of the cooks such as air-conditioner, ventilator, etc., the working condition remains bad. The best way to solve the problem is to get the cooks away from the ovens forever.

Presently semi-automatic cooking appliances such as microwave oven, toaster, electric rice cooker, electrical oil frying pan, est. have been used widely in kitchen practice. However none of those appliances possesses the function of full-automatic cooking. That means a lot of manpower is needed in the process of food preparing, like loading-unloading materials, setting parameters, cleaning, est.

In recent years, Chinese cuisine is getting more and more popular in this country. An obstacle, which will restrain it from getting even more popular, is the unstable quality and the difference in flavor for the same kind of dish, since the quality and flavor of a Chinese dish almost all depends on the cook's personal skills and taste.

To solve the problems enumerated above, several types of full-automatic cooking machines have been proposed mainly in China, for example, CN 86105228A to Tangman Wang (1987), CN 2115730U to Xiaozhong Feng (1992), CN 1158715A to Sheng Xishan (1997), CN 2262392Y to Yawang Li (1997), CN 2326132Y to Jun Zhang (1999), CN 2330277Y to Xianghu Wang (1999), CN 1233448A to Ziqiang Huang (1999), CN 1236589A to Jun Luo (1999), CN 1238163A to Qiang Hu (1999), CN 1245042A to Jun Luo (2000), CN 1254542A to Mingsen Tan (2000), etc.

Although all of the inventions mentioned above attempt to realize the ideal of full-automatic cooking, that is, automatic loading raw ingredients, automatic heating, automatic stir-frying, automatic adding seasonings, condiments and sauces, automatic dispensing and automatic cleaning, each of these inventions has it's own limitations and problems. None of them has met those criteria. It is because there exist some defects in those inventions that those inventions become nonfunctional more or less.

Firstly, non of them uses automatic collection system, that means a lot of manpower needed in raw ingredient supply, the quantity of ingredients for a kind of dish will not be the same for each dish. So the quality of the dishes will not stable.

Secondly, non of them uses separate working section to execute jobs totally different, that means they will interfere with each other on working.

For example, the raw ingredients need to store in refrigerator, while the cooking section will produce lot of heat.

Thirdly, non of them uses multiple work stations and rotatable multi-pans system in cooking, that means non of them work in a parallel way. That is not an efficient way of work.

Finally, non of them has a practicable auxiliary material supply system, such as, seasoning supplier, condiment supplier, liquid sauce supplier, paste sauce supplier, etc. That will make those inventions nonfunctional.

### SUMMARY

In accordance with the present invention a full-automatic cooking machine consists of four major sections: the control and power section, the raw ingredient storage and supply section, the pre-cooking section and the cooking section.

The control and power section comprises a programmable controller, electrical power source, an air compressor, electric motors, pneumatic cylinders, contactors, relays, limit switches, sensors, and valves, etc.

The raw ingredient storage and supply section comprises an alley formed with two ‘wall’s, which consist of hundreds of supply drawers located on both sides of it. The drawers have controllable doors in the front opened to the alley, in which all kinds of raw ingredient (meats, vegetables, etc.) for a variety of dishes are stored. There is a rectangular coordinates manipulator with a collecting basket moving along the alley between two ‘wall’s capable of reaching each drawer's door. There is a refrigerator attached to this section.

The pre-cooking section comprises a boiling water pot, several deep frying oil pots.

The cooking section consists of multiple working stations, for the preferred embodiment—four: the loading station, the stir-frying and dispensing station, the cleaning station and the pre-heating station. There are four horizontally rotatable frying pans mounted on a turntable capable of being revolved to the four stations in turn. Each working station has a controllable burner mounted underneath to heat the frying pan revolved onto it.

On the loading station, there is a flip up mechanism mounted in front of it associated with manipulator moving along the alley.

There is a pendent robot arm with a stir spatula mounted above the stir-frying and dispensing station and a flip up mechanism mounted in front of it for dispensing the finished dishes. There are the outlets of a condiment supplier, a liquid sauce supplier and a paste sauce supplier fixed above it.

On the cleaning station, there is a cleaning mechanism mounted above the cleaning station and a flip up mechanism mounted in front of it for pouring out the used detergent.

On the pre-heating station, there is an outlet of a liquid sauce supplier (to supply with frying oil) and a seasoning supplier mounted above it.

### OBJECTS AND ADVANTAGES

Accordingly, several objects and advantages of the present invention are:

(a) to provide a cooking machine which is a veritable full-automatic cooking machine. It can cook variety of dishes automatically and continuously without the participating of manpower. That means it can complete all the procedures of cooking by itself: selecting and loading the raw ingredients, heating and stir-frying them in a pan, adding seasonings, condiments and sauces into a dish being cooked timely and properly, dispensing the dish when finished, cleaning and drying up the used pan for the next dish.

(b) to provide a cooking machine which can serve out each dish of a kind with the same quality and flavor anytime and anywhere, because the quantity and timing of all kind of ingredients, the duration and degree of heating are controlled by a programmable controller without any interfering of the cook's personal taste and skill.

(c) to provide a cooking machine which can serve out dishes of high quality, because all the factors related to cooking can be adjusted to the finest extent by the programmable controller.

(d) to provide a cooking machine which can bring forth new dishes to meet customer's unceasing tastes for food easily, because it is convenient to change the recipes controlled by the programmable controller.

(e) to provide a cooking machine which can serve out dishes of high quality, because all the raw ingredients needed for the dishes are kept fresh in a refrigerated storage before cooking.

(f) to provide a cooking machine which is a most efficient one because it works in a parallel way. While the cooking section is busy with the cooking, the manipulator can pick up raw ingredients simultaneously in the raw ingredient storage and supply section. The four working stations of the cooking section can work in a parallel way as well. That will save lot of time of waiting for the prior procedure to be finished.

(g) to provide a cooking machine which can saves cooks from the working environments of suffering from high temperature and harmful smoke thoroughly.

(h) to provide a cooking machine which can extremely reduces the air pollution both inside and outside the kitchen, because the pre-cooking section and the cooking section are designed closed in a cabin, the smoke produced in cooking will be eliminated with a smoke treatment ventilator mounted on the ceiling of the cabin.

Still further objects and advantages will become apparent from a consideration of the ensuing description and drawings.

### DRAWING FIGURES

FIG. 1 shows the appearance of a preferred embodiment of the full-automatic cooking machine.

FIG. 2 shows the detailed structure of said full-automatic cooking machine.

FIG. 3 shows the structure of a unit of the liquid sauce supplier of said full-automatic cooking machine.

FIG. 4 shows the structure of a unit of the paste sauce supplier of said full-automatic cooking machine.

FIG. 5 shows the structure of a unit of the condiment supplier of said full-automatic cooking machine.

FIG. 6 shows the structure of a unit of the seasoning supplier of said full-automatic cooking machine.

FIG. 7 shows the structure of a supply drawer of said full-automatic cooking machine.

### REFERENCE NUMERALS IN DRAWINGS

1 electric control cabinet 2 smoke treatment ventilator

3 raw ingredient storage and supply section 4 refrigerator

5 supply drawer 6 pre-cooking section

7 dispensing chute 8 cooked food container

9 cooking section 10 drainage

11 turntable and its supporter 12 flip up mechanism

13 base for whole machine 14 liquid sauce supplier

15 cleaning station 16 pre-heating station

17 condiment supplier 18 seasoning funnel

19 seasoning supplier 20 cleaning mechanism

21 loading funnel 22 ball slideway supporter

23 rack 24 ball slideway

25 heat insulation door 26 x-axis driving servo motor

27 z-axis driving servo motor 28 manipulator and its x-axis carriage

29 manipulator's z-axis carriage 30 y-axis translation mechanism

31 guide post 32 ball screw

33 collecting basket 34 electric scale

35 deep frying oil pot 36 boiling water pot

37 flip up mechanism 38 robot arm with spatula

39 loading station 40 flip up mechanism

41 stir-frying and dispensing station 42 controllable burner

43 gear ring 44 rotation driving motor

45 revolution driving motor 46 base

47 low liquid level sensor 48 container

49 outlet 50 servo motor

51 motion transform mechanism 52 coupling

53 up limit switch 54 cylinder

55 piston 56 down limit switch

57 check valve 58 check valve

59 check ball 60 container

61 outer sleeve 62 O ring

63 cylinder supporter 64 pneumatic cylinder

65 check valve 66 inner sleeve

67 outlet 68 low liquid level sensor

69 vibrator 70 container

71 sifter 72 cylinder supporter

73 pneumatic cylinder 74 upper passage hole

75 coupling 76 chambered collecting rod

77 chamber 78 down hole

79 longitudinal through hole 80 crosswise through hole

81 body 82 container

83 scraper 84 chain gear wheel

85 conveyer belt 86 passage

87 photoelectric sensor 88 passive belt wheel

89 chain 90 chain

91 pick up basket 92 combination of conveyer and door

93 driven gear wheel 94 side plate

95 pulley 96 drawer body

97 steel cable 98 pneumatic cylinder

99 push plate 100 back door

101 driving electric motor 102 steel cable

103 bottom plate 104 driving gear wheel

105 pulley 106 gear wheel set

107 spring 108 connector

109 outlet 110 driving chain wheel

111 paste sauce supplier

Description

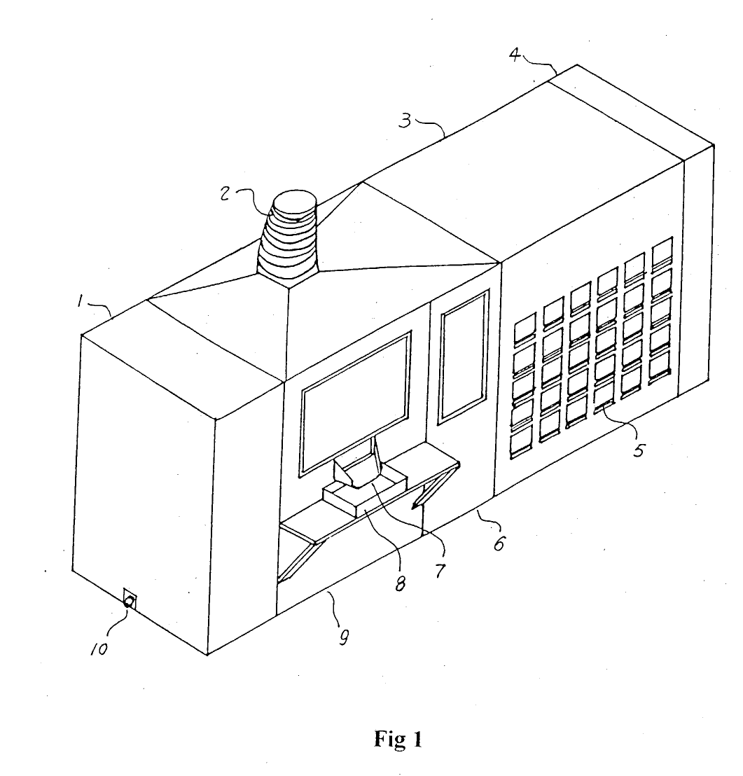

A preferred embodiment of the full-automatic cooking machine of the present invention is illustrated in FIG. 1 through FIG. 7.

FIG. 1 shows the appearance of the full-automatic cooking machine. It consists of several blocks: an electric control cabinet 1, a cooking section 9, a pre-cooking section 6, a raw ingredient storage and supply section 3 and a refrigerator 4 integrated into a box-shaped machine body with a dispensing chute 7 in the front of it for dispensing the cooked food. An electrical power source and a compressed air source input at the back (not shown). The cooking section 9 and the pre-cooking section 6 comprises a cabin with a smoke treatment ventilator 2 mounted in the ceiling of it. There is a drainage 10 mounted on the side of the machine.

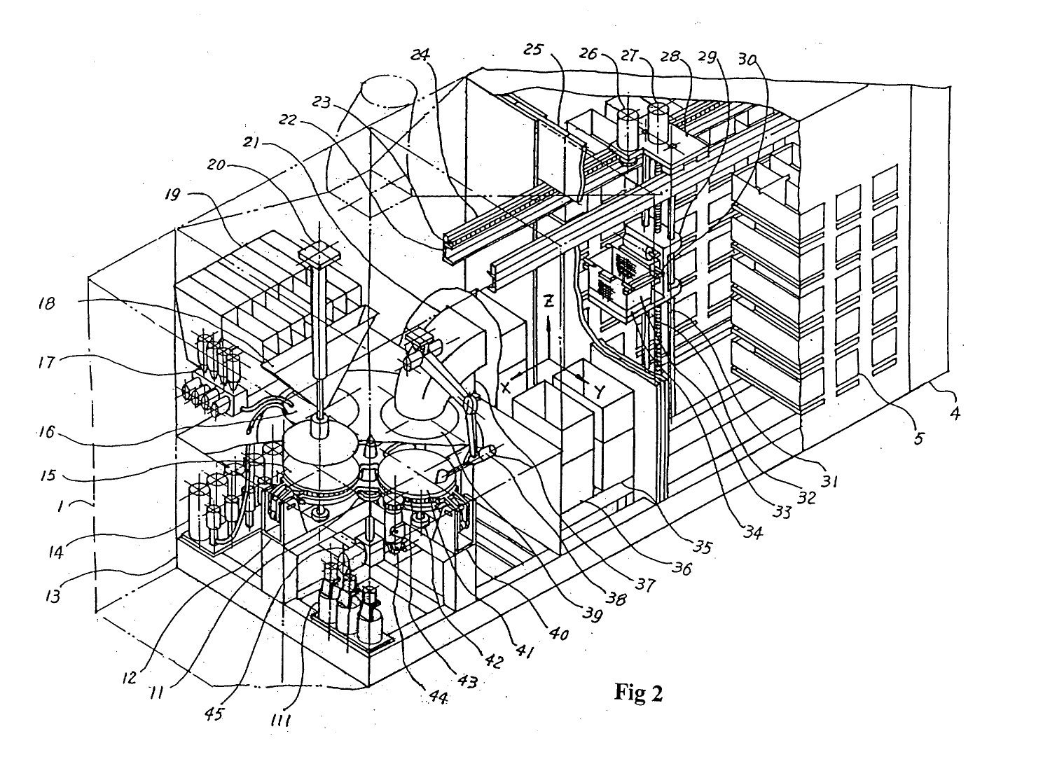

FIG. 2 shows the detailed structure of the full-automatic cooking machine.

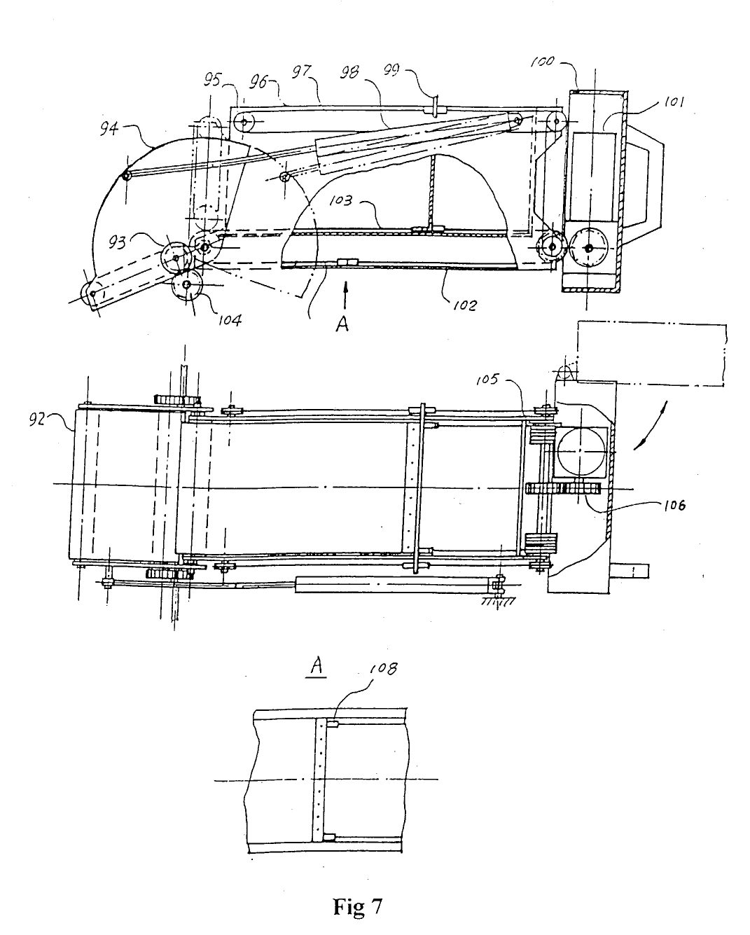

The raw ingredient storage and supply section 3 (see FIG. 1) comprises an alley formed with two ‘wall ’s, which consist of hundreds of supply drawers 5, in which all kinds of ingredient (meats, vegetables, etc.) for a variety of dishes are stored. Each drawer has a controllable combination of conveyer and door 92 (see FIG. 7) in the front of it, capable of opening to the alley.

There is a rectangular coordinates manipulator 28 with its collecting basket 33 moving along the alley, which can reach each drawer. The motion of the manipulator along x-axis is guided by a ball slideway 24, driven by the x-axis driving servo motor 26 through the meshing with the rack 23. The motion of the manipulator's collecting basket along z-axis is guided by a guide post 31, driven by the z-axis driving servo motor 27 through the meshing of the ball screw 32 and the z-axis carriage 29. The motion of the manipulator's collecting basket along y-axis is driven by the y-axis translation mechanism 30, which is mounted on the z-axis carriage 29. There is an electric scale 34 mounted on the carriage under the collecting basket 33 for weighing the weight of the raw ingredients in it, collected by the manipulator. There is an automatic heat insulation door 25 mounted between the raw ingredient storage and supply section 3 (see FIG. 1) and the pre-cooking section 6 (see FIG. 1).

The pre-cooking section 6 (see FIG. 1) comprises a boiling water pot 36, several deep frying oil pots 35. The manipulator can immerse the collecting basket 33 with the raw ingredients in it into each of the pots through the combination of x, y and z axes' motions. There is a flip up mechanism 37 mounted at the end of the alley between the pre-cooking section 6 and the cooking section 9 (see FIG. 1) for dispensing the pre-cooked raw ingredients in the collecting basket into the frying pan revolved onto the loading station 39 through the loading funnel 21.

The cooking section 9 consists of four working stations: the loading station 39, the stir-frying and dispensing station 41, the cleaning station 15, the pre-heating station 16. There are four frying pans horizontally rotatable mounted on a turntable 11, which can be revolved to the four working stations in turn by a revolution driving motor 45. Each working station has a controllable burner 42 mounted underneath to heat the frying pans revolved onto it.

There is a pendent robot arm with spatula 38 mounted above the stir-frying and dispensing station and a flip up mechanism 40 mounted in front of it for dispensing the finished dishes. There is a rotation driving motor 44 mounted underneath to rotate the frying pan revolved onto it through the meshing with the gear ring 43. There are the outlets of a condiment supplier 17, supplying with powdery condiments, the liquid sauce supplier 14, supplying with liquid sauces and a paste sauce supplier 111, supplying with paste sauces fixed above it.

On the cleaning station 15, there is a cleaning mechanism 20 mounted above it for cleaning the used frying pan and a flip up mechanism 12 mounted in the front of it for pouring out the used water and detergent.

On the pre-heating station 16 there are the outlets of the condiment supplier 17, the liquid sauce supplier 14, the paste sauce supplier 111 and a seasoning supplier 19 mounted above it.

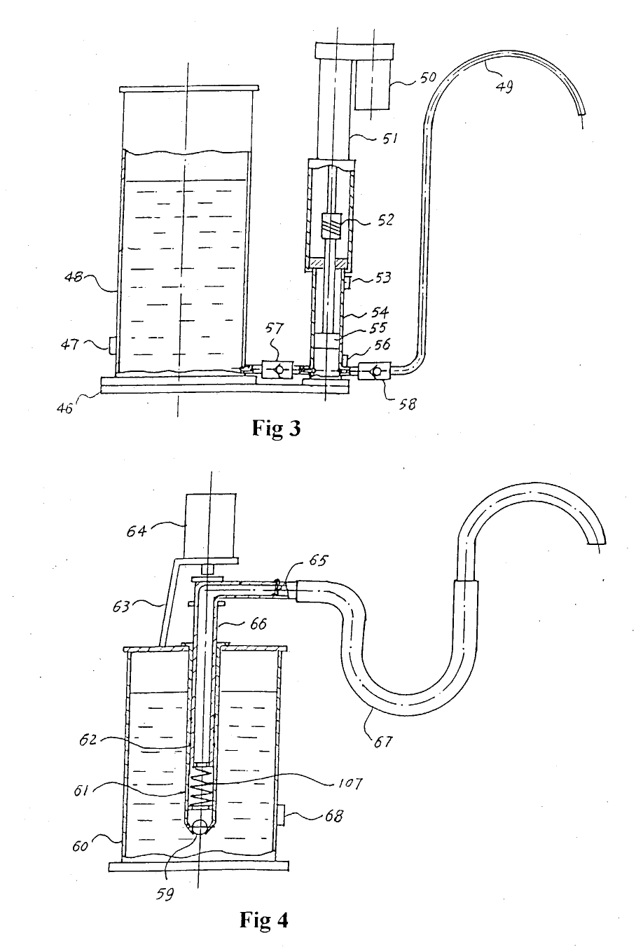

FIG. 3 shows the structure of a unit of the liquid sauce supplier of the machine. Each unit supplies with a kind of liquid sauce, and several such units are integrated into the liquid sauce supplier 14 (see FIG. 2).

In FIG. 3, there is a piston 55 capable of moving up or down inside the cylinder 54, driven by a servo motor 50 controlled by the programmable controller through a motion transform mechanism 51 and a coupling 52. Consequently, the motion of the piston 55 is controlled by the programmable controller. With the help of two check valves 57 and 58, on each travel of up and down, the piston will take some of liquid sauce into the cylinder 54 and then dispense it out through the outlet 49. The quantity of the liquid sauce dispensed depends on the distance of the travel of the piston, which is controlled by the programmable controller as well.

FIG. 4 shows the structure of a unit of the paste sauce supplier of the machine. Each unit supplies a kind of paste sauce, and several such units are integrated into the paste sauces supplier 111 (see FIG. 2).

In FIG. 4, there is a hollow inner sleeve 66, having an opening at the bottom, capable of moving up or down inside the outer sleeve 61. The inner sleeve 66 can be pressed down by a pneumatic cylinder 64 mounted above it, and spring up to the original position by the spring 107. With the help of a check ball 59 and a check valve 65, on each travel of up and down, the inner sleeve will take some paste sauce in and then dispense it out through the outlet 67. The quantity of the paste sauce dispensed depends on the times of stroke of the cylinder, which is controlled by the programmable controller.

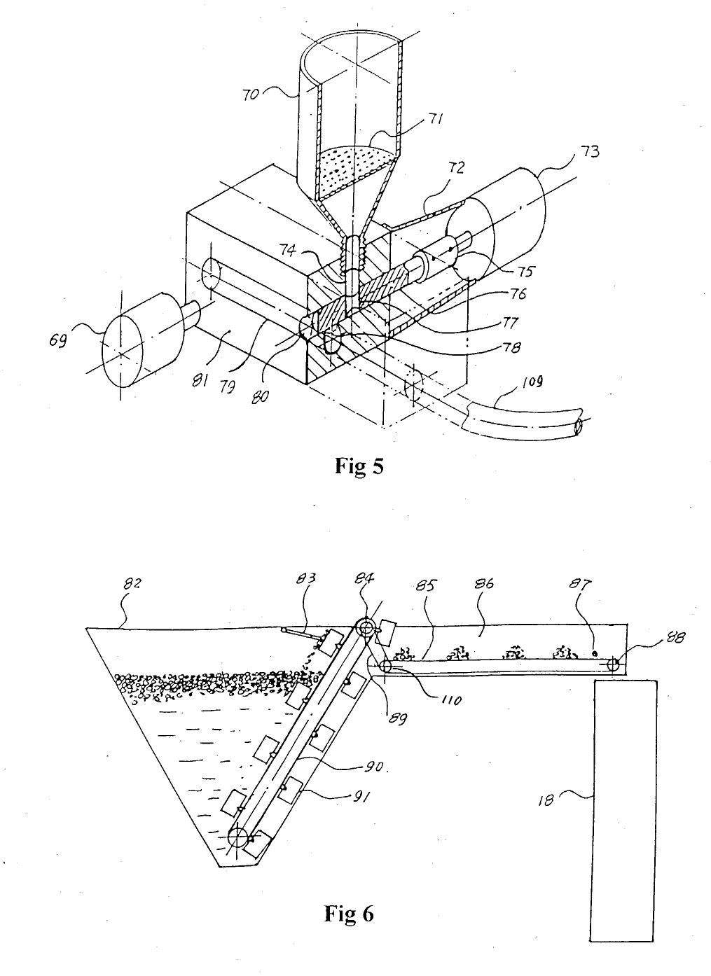

FIG. 5 shows the structure of a unit of the condiment supplier of the machine. Each unit supplies with a kind of condiment, and several such units are integrated into the condiments supplier 17 (see FIG. 2).

In FIG. 5, there is a body 81 of the condiment supplier with a longitudinal through hole 79 interlinked with a crosswise through hole 80 forming a down hole 78. There is an upper passage hole 74 interlinked with the crosswise through hole perpendicularly, and the other end of it is connected with a container 70 filled with a kind of condiment. A chambered collecting rod 76, driven by a pneumatic cylinder 73 with a crosswise through chamber 77 in it, moves along the crosswise through hole 80 back and forth. The chamber 77 communicates with the upper passage hole 74 at the back limit, taking in the condiment stored in the container 70, and communicates with the down hole 78 at the forth limit, dispensing the condiment collected at the back limit into the longitudinal through hole 79.

After all kind of condiments needed for a dish has been collected in the longitudinal through hole, a gust of compressed air will dispense them out through the outlet 109. There is a vibrator 69 mounted aside the body 81 with its vibration head keeping touch against the body for vibrating the unit while it is working.

The quantity of the condiment dispensed depends on the volume of the chamber and the times of stroke of the cylinder 73, which is controlled by the programmable controller.

FIG. 6 shows the structure of a unit of the seasoning supplier of the machine. Each unit supplies a kind of seasoning, and several such units are integrated into the seasoning supplier 19 (see FIG. 2)

In FIG. 6, there are two conveyers interlinked with each other by a chain 89, driven by a electric motor (not shown) through a chain gear wheel 84.

The first conveyer consists of the chain gear wheel 84, a chain 90 interlocked with several pick up baskets 91 equally scattered along it, installed inside a container 82. The pick up basket has an opening in the front. The second conveyer consists of a conveyer belt 85, a driving chain wheel 110, a passive belt wheel 88, installed inside a passage 86. A photoelectric sensor 87 mounted in the side wall of the passage above the surface of the belt. A seasoning funnel 18 fixed under the outlet of the passage.

When the pick up baskets 91 move clockwise inside the container, each pick up basket will be filled up with the same quantity of the seasoning. After passing the returning point, the pick up baskets will dispense the seasoning onto the belt of the second conveyer, forming small piles equally scattered on it, because the movements of the two conveyers are interlinked. Along with the belt moves forward, the piles fall into the seasoning funnel one by one. The total quantity of the seasoning dispensed controlled by the programmable controller according to the signals sent out by the photoelectric sensor.

FIG. 7 shows the structure of a supply drawer of the machine. The drawer has a push plate 99 transitionally moving along with a bottom plate 103 inside the body 96, driven by a system of steel cable and pulleys. The system consists of steel cable 97, 102, pulleys 95, 105, the bottom plate 103 and connectors 108, which is driven by a electric motor 101 mounted inside the back door 100. When the back door is closed, the motor can drives the system through a meshed gear wheel set 106. There is a combination of conveyer and door 92 pivotably mounted in front of the drawer, keeping touch against the bottom plate, driven by another motor (not shown) through the mesh of the driving gear wheel 104 and the driven gear wheel 93. The combination of conveyer and door is flipped by a pneumatic cylinder 98, which is pivotably connected with the combination's side plate 94.

Operation

To operate the full-automatic cooking machine, first of all, we have to compile the programs for each dish according to the recipe, then load them into the library of the programmable controller one by one. Compiling and editing the programs is the most difficult procedure of the operation, because there are too many dishes in Chinese cuisine, and for each dish there are too many factors to be controlled: the shape and quantity of various raw ingredients, the seasonings, the condiments, the liquid and paste sauces to be add, the procedure and timing of the operation, the duration and degree of heating, the speed and manner of stirring, etc.

Thanks to the perfect design of the machine, make the control of all the above factors possible. The thing to be done is carefully compiling, editing and loading the programs and adjust them to the finest extent, in order to serve out dishes of high quality with the full-automatic cooking machine.

After the completion of the program compiling, editing and loading, the use of the machine will be very convenient. Whatever dish or dishes are ordered, as long as there is a program for it in the library of the machine, what needed to do is only to key in the code of the dish and the quantity one by one, the machine will serve out the dish or dishes one by one full-automatically.

Because all the actions of the machine is controlled by the programmable controller by giving instructions according to the program and signals feedback by the sensors, limit switches. For briefing, in the following description we are going to describe the action of the machine in such a way as if it acted on itself.

In the raw ingredient storage and supply section, there is an alley formed with two ‘wall’s, which consist of hundreds of supply drawers 5 having the combination of conveyer and door 92, capable of opening to the alley.

As soon as the code of the dish is keyed in and the start command is given, the manipulator 28 with its collecting basket 33 will move along the alley to the front outlet of one of the supply drawer 5, driven by the x-axis driving servo motor 26 and the z-axis driving servo motor 27, to collect the first raw ingredient. On arriving at the outlet, the cylinder 98 will push the combination of conveyer and door 92 down to form a bridge between the supply drawer and the collecting basket. Then the push plate 99 along with the bottom plate 103 will move forward to push the raw ingredient stored in this drawer into the collecting basket through the ‘bridge’, driven by the motor 101 through the steel cable and pulley system. The moment the weight of the raw ingredient weighed by the electric scale 34 match the value pre-set by the program, the electric scale will give signal to the controller. Then the push plate 99 will stop moving immediately and the combination of conveyer and door will turn up back to perpendicular position simultaneously clearing the alley to let the manipulator pass. So far the collection of the first ingredient has been completed. And so on and so forth, the manipulator will finish the collection of all the raw ingredients needed for the kind of dish in proper order.

Having finished the collecting of the raw ingredients, the manipulator with the collecting basket will move into the pre-cooking section 6, through the heat insulation door 25. The door is always kept closed except for the pass of the manipulator. In the pre-cooking section, the manipulator will has the collecting basket immersed into the boiling water pot 36 or the deep frying oil pot or both to pre-cook the raw ingredients collected in the basket, according to the program, through the combination of x, y, z-axis motion.

Having finished the pre-cooking procedure, the manipulator will move to the end of the alley. There is a flip up mechanism 37 mounted there waiting for the manipulator to come. As soon as the manipulator arrives at the flip up mechanism, it will clamp the collecting basket and flip it up to dispense the pre-cooked raw ingredients through the loading funnel 21 into a frying pan revolved onto this loading station 39 in the cooking section 9 few seconds ago from the pre-heating station 16. Because this machine works in a parallel way, while the manipulator is busy with the collecting, a pan is pre-heated on the pre-heating station with frying oil and seasonings needed in it, getting ready to be revolved onto the loading station.

As soon as the loading of pre-cooked ingredients finishes, the revolution driving motor 45 will revolves the frying pan loaded onto the stir-frying and dispensing station 41 by the turntable 11. On this station, with the controllable burner 42 heating underneath, the ingredients will be stir-fried properly with a robot arm with spatula 38, having the condiments, seasonings, liquid and paste sauces of the right quantity added at the right time according to the recipe. While the robot arm is stirring and frying the ingredients in the pan, a rotation driving motor 44 will rotate the pan through the gear ring 43, to improve the effect of frying.

When the cooking is completed, the flip up mechanism 40 mounted in front of this station will clamp the pan and flip it up to dispense the finished dish into a cooked food container 8 through a dispensing chute 7. After dispensing out the finished dish, the flip up mechanism will flip down the empty pan to the turntable 11. Then, the turntable will rotate again to revolve the used pan onto the cleaning station 15.

When the used pan is revolved onto the cleaning station, a cleaning mechanism 20 will get down and clean the used pan with brush, hot water, detergent. When the cleaning is finished, a flip up mechanism 12 will clamp the pan and flip up it to pour out the used water and detergent through the drainage 10 in the side wall of the machine. The cleaned pan will be dried by a burner, heating the pan underneath.

The cleaned and dried pan will be revolved onto the pre-heating station 16, to be loaded with frying oil, seasonings, then pre-heated for the next dish.

### CONCLUSION, RAMIFICATIONS AND SCOPE

Accordingly, the reader will see that the full-automatic cooking machine of this invention can be used in kitchen easily and conveniently, especially in restaurant. It is a veritable full-automatic cooking machine. It can cook a variety of dishes automatically and continuously without any participating of manpower. It can serve out each dish of a kind with the same quality and flavor. Furthermore it can serve out dishes of high quality, because all the raw ingredients are kept fresh in the refrigerated storage before cooking, and the selecting of the raw ingredients is performed by a manipulator, that way the contamination from manpower will be reduced to the minimum extent.

Although the description above contains much specificity, these should not be construed as limiting the scope of the invention but as merely providing illustrations of the presently preferred embodiment of this invention. For example, the cooking section can comprises more or less working stations and frying pans, etc.; the robot arm with spatula can be replaced by a less complicated mechanism, etc.

Thus the scope of the invention should be determined by the appended claims and their equivalents, rather than by the examples given.

I claim:

1. A food processor for cooking raw ingredients, comprising:
(a) a programmable control device for control all the actions of said food processor,
(b) a self-driven device having a collecting container controlled by said programmable control device capable of getting to a plurality of raw ingredient supply drawers for collecting raw ingredients needed for cooking,
(c) a plurality of frying pans mounted on a rotatable frame, capable of being revolved to a plurality of working stations in turn controlled by said programmable control device so that said food processor can work in a parallel way
whereby said food processor will cook a variety of food full-automatically, conveniently, efficiently without any participation of manpower.

2. The food processor of claim 1 wherein said programmable control device is a programmable controller.

3. The food processor of claim 1 wherein said self-driven device is a rectangular coordinates servo manipulator.

4. The food processor of claim 1, further including a pendent servo robot arm with spatula for stir-frying the food in the frying pan.

5. The food processor of claim 1, further including a liquid sauce supplier having a electric servo motor for driving a means of supplying with certain quantity of a kind of liquid sauce controlled by said programmable control device.

6. The food processor of claim 1, further including a condiment supplier having a pneumatic cylinder for driving a means of supplying with certain quantity of a kind of condiment controlled by said programmable control device.

7. The food processor of claim 6 wherein said condiment supplier has an electric vibrator with its vibration head keeping touch the body of said condiment supplier for vibrating said condiment supplier while working.

8. The food processor of claim 1, further including a seasoning supplier having a chain conveyer with equally scattered pick up basket for picking up a kind of seasoning from a funnel-shaped container.

9. The food processor of claim 1, further including a plurality of supply drawers, which has a push plate moving along with a bottom plate driven by an electric motor for supplying with a kind of raw ingredient

10. The food processor of claim 9 wherein said supply drawer has a electric motor for driving said push plate and said bottom plate mounted inside the back door of said supply drawer.
